(19) United States
(12) Patent Application Publication
(10) Pub. No.: US 2024/0104224 A1
(43) Pub. Date: Mar. 28, 2024

(54) PRIVACY-PRESERVING SEARCH USING HOMOMORPHIC ENCRYPTION

(71) Applicant: Intel Corporation, Santa Clara, CA (US)

(72) Inventors: Ernesto Zamora Ramos, Folsom, CA (US); Kylan Race, Austin, TX (US); Jeremy Bottleson, North Plains, OR (US); Jingyi Jin, San Jose, CA (US)

(73) Assignee: Intel Corporation, Santa Clara, CA (US)

(21) Appl. No.: 17/935,826

(22) Filed: Sep. 27, 2022

(51) Int. Cl. G06F 21/60; H04L 9/00; H04L 9/08

(52) U.S. Cl. CPC G06F 21/602; H04L 9/008; H04L 9/0825

(57) ABSTRACT

An improved search operation includes receiving, by a server computing device, an encrypted search query and cleartext metadata associated with the encrypted search query from a client computing device; performing a search using the encrypted search query to generate encrypted search results; and sending the encrypted search results to the client computing device.

### FIELD OF THE DISCLOSURE

This disclosure relates generally to security in computing systems, and more particularly, to protecting the privacy of searches and search results in computing systems using homomorphic encryption.

### BACKGROUND

One of the most frequently used processes in computing is searching for data, such as on the World Wide Web (WWW) of the Internet or on an intranet. Service providers providing search processes (such as those capabilities provided by Google, Microsoft Bing, Yahoo, etc.) have spent significant resources attempting to improve the accuracy of their search algorithms. The data that is generated from the user searches has helped to assist this, but also has proven to be a valued asset. The data economy has gotten to the point that user data (and the conclusions that can be drawn from the user data (e.g., data mining)) may become more valuable to service providers than even advertising revenue. However, this introduces a significant privacy issue. To gain the benefit of the search services, users must effectively surrender ownership of their web searches. User search queries are captured locally by software on the client's device. These queries often capture a wide range of data from spending habits users, situations in the personal lives of users, and topics being researched. The detailed profiles that are built based on how users interact with the Internet through searching may be used in some cases to identify users. Users may desire that their search queries be considered private, sensitive, and protected.

### BRIEF DESCRIPTION OF THE DRAWINGS

FIG. 1 illustrates a computing system providing protection of privacy when using a search process according to an example.

FIG. 2 is a flow diagram of client application processing in an example.

FIG. 3 is a flow diagram of server application processing according to an example.

FIG. 4 is a flow diagram of client application processing according to an example.

FIG. 5 is an example of a MapReduce flow diagram.

FIG. 6 is a diagram a word count search using MapReduce according to an example.

FIGS. 7A and 7B are diagrams of word count search using MapReduce with homomorphic encryption according to an example.

FIG. 8 is a block diagram of an example processor platform structured to execute and/or instantiate the machine-readable instructions and/or operations of FIGS. 1-7 to implement the apparatus discussed with reference to FIGS. 1-7.

FIG. 9 is a block diagram of an example implementation of the processor circuitry of FIG. 8.

FIG. 10 is a block diagram of another example implementation of the processor circuitry of FIG. 8.

FIG. 11 is a block diagram illustrating an example software distribution platform to distribute software such as the example machine readable instructions of FIG. 8 to hardware devices owned and/or operated by third parties.

The figures are not to scale. In general, the same reference numbers will be used throughout the drawing(s) and accompanying written description to refer to the same or like parts.

### DETAILED DESCRIPTION

The technology described herein provides a method, system, apparatus and machine-readable storage medium to improve protection of privacy for searches in a computing system. Homomorphic encryption (HE) allows computations to be performed on encrypted data without revealing input and output information to service providers. The technology described herein provides a search system where the user's data (such as a search query) is encrypted locally on the user's computing device using HE. The encrypted search query is then sent over a network (such as the Internet) to a remote service provider providing a search function. The service provider inputs the encrypted search query to an HE variant of a search process (e.g., MapReduce, Google Search, Hadoop, etc.). The search process generates encrypted search results and sends the encrypted search results back to the user. Since the search query is encrypted, a HE variant of the search process is used, and encrypted search results are generated, only the user can decrypt the encrypted search query and encrypted search results. This protects the privacy of the user's data (both the search query and search results) from disclosure to the service provider.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections.

As used herein, “processor” or “processing device” or “processor circuitry” or “hardware resources” are defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s). As used herein, a device may comprise processor circuitry or hardware resources.

As used herein, a computing system or computing device can be, for example, a server, a personal computer, a workstation, a self-learning machine (e.g., a neural network), a mobile device (e.g., a cell phone, a smart phone, a tablet (such as an iPad′)), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, an electronic voting machine, or any other type of computing device.

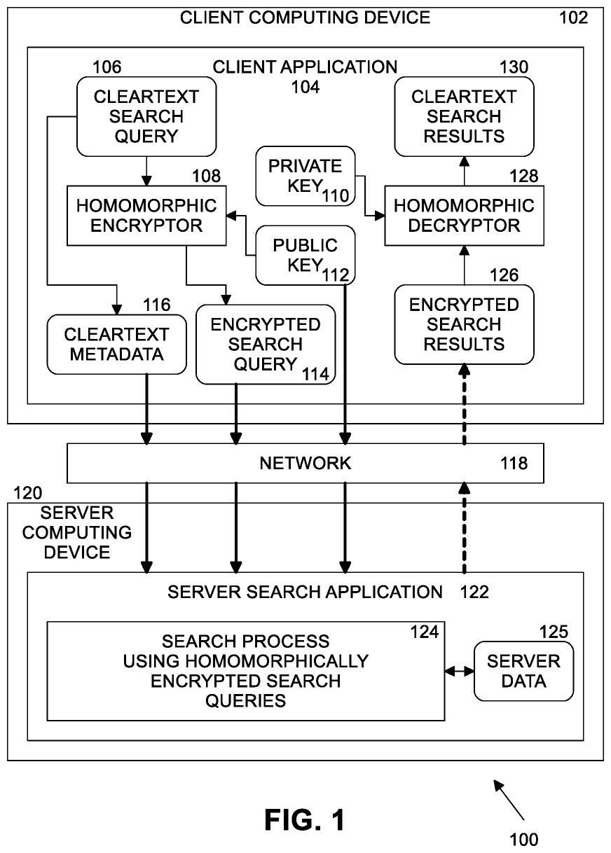

The technology described herein improves the protection of privacy of a user's search query and search results in a computing system. FIG. 1 illustrates a computing system 100 providing protection of privacy for using a search process according to an example. Client computing device 102 (e.g., a computing system such as a personal computer, smart phone, tablet computer, etc.) includes client application 104. In one capability, client application 104 provides an interface to a search process provided by a server search application 122 of a server computing device 120. In an example, the client computing device 102 is coupled to the server computing device 120 by network 118 (such as the Internet or an intranet). When a user of client computing device 102 desires to perform a search, the user enters cleartext search query 106 to client application 104 of client computing device 102 using any suitable input mechanism (e.g., keyboard, touch screen, microphone (and speech-to-text capability), etc.). Cleartext search query 106 is unprotected. That is, the search query is initially in a clear text format (e.g., not encoded or encrypted and easily readable by anyone). In various examples, cleartext search query 106 is a string of characters, an image, or any stream of data provided by the user. Client application 104 (or via an available cryptographic library, for example) generates a cryptographic key pair including private key 110 and public key 112. Private key 110 is never exposed outside of client application 104. Homomorphic encryptor 108 encrypts cleartext search query 106 using an HE process using public key 112 to generate encrypted search query 114. Client application 104 also extracts cleartext metadata 116 from cleartext search query 106. Cleartext metadata 116 comprises implementation dependent information regarding the search process to be performed (e.g., associated with the cleartext search query 106), including HE parameters such as type of search, query length, multiplicative depth, security level, type of primitive operations and so on. Cleartext metadata 116 is in the clear (e.g., unencrypted) and accessible by anyone.

In some implementations, cleartext metadata 116 may include a description of one or more data input formats, such as a word per-ciphertext. This may be change if the search had a limit on HE parameter size, for example, limiting how much could be stored in a single ciphertext. Map-Reduce for a word-count search is one example shown below, and the indication of the task being performed (e.g., word-count search) may be conveyed in the cleartext metadata to the server search application 122. Cleartext metadata 116 includes information on HE parameters because the items listed (e.g., multiplicative depth, security level, etc.) may limit the type of algorithm that may be used to operate on the data on the server computing device 120. In one implementation, cleartext metadata 116 may be a free form text file. In other implementations, cleartext metadata 116 may include a user input template containing various options for the search functions supported by server search application 122 (for example, a form with multiple choices per question). Then in cleartext, the client application 104 specifies the various parameters for the search function.

Client application 104 sends encrypted search query 114, cleartext metadata 116 and public key 112 to server search application 122.

Server search application 122 comprises a search process using homomorphically encrypted search queries 124 on server data 125. This search process is a variant of a search process and adapted to process homomorphically encrypted search queries. Search process using homomorphically encrypted search queries 124 processes encrypted search query 114, cleartext metadata 116, and public key 112 to generate encrypted search results 126. Encrypted search results 126 are encrypted using public key 112 of the user inside a HE process within search process using homomorphically encrypted search queries 124. Portions of server search application 122 (including search process using homomorphically encrypted search queries 124) may be implemented in a parallel manner by computing such portions on a plurality of compute nodes (e.g., processing cores)(not shown in FIG. 1) implemented by server computing device 120.

Server search application 122 sends encrypted search results 126 back to the requesting client application 104. Homomorphic decrypter 128 of client application 104 decrypts encrypted search results 126 using private key 110 to produce cleartext search results 130. The user may then examine or otherwise use the results from the search query.

Since the search query is never represented as cleartext at the server level within server computing device 120 and the search process generates encrypted search results 126, the server computing device 120 does not have access to the user's search query or search results. Further, the search query and the search results are never sent in the clear over the network 118.

In an example, one or more of homomorphic encrypter 108, homomorphic decrypter 128, and/or search process using homomorphically encrypted search queries 124 are implemented as software instructions executed by a processor. In another example, one or more of homomorphic encrypter 108, homomorphic decrypter 128, and/or search process using homomorphically encrypted search queries 124 are implemented as hardware circuitry. In another example, one or more of homomorphic encrypter 108 and/or homomorphic decrypter 128 are implemented as one or more ASICs or FPGAs in client computing device 102. In another example, search process using homomorphically encrypted search queries 124 is implemented as an ASIC or FPGA in server computing device 120.

In an example, homomorphic encrypter 108 and homomorphic decrypter 128 implement any suitable HE process (Brakerski, Gentry, Vaikuntanathan (BGV), Cheon, Kim, Kim, Song (CKKS), Fully Homomorphic Encryption, etc.).

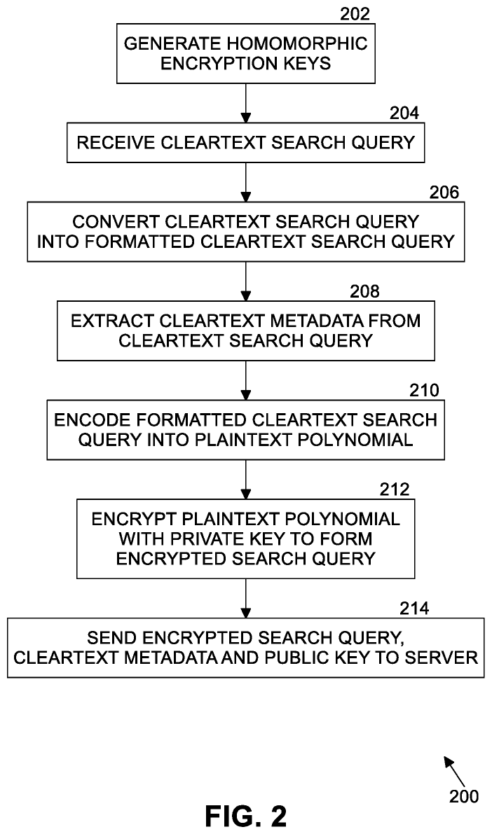

FIG. 2 is a flow diagram of client application processing 200 in an example. At block 202, client application 104 generates homomorphic encryption keys (e.g., private key 110 and public key 112). At block 204, client application 104 receives cleartext search query 106 from the user. At block 206, client application 104 converts the cleartext search query into a formatted cleartext search query according to requirements of search process using homomorphically encrypted search queries 124. At block 208, client application 104 extracts cleartext metadata 116 from cleartext search query 106. At block 210, client application 104 encodes the formatted cleartext search query into one or more plaintext polynomials. At block 212, homomorphic encryptor 108 encrypts the plaintext polynomial with private key 110 to form encrypted search query 114. At block 214, client application 104 sends encrypted search query 114, cleartext metadata 116 and public key 112 to server search application 122 of the server computing device 120.

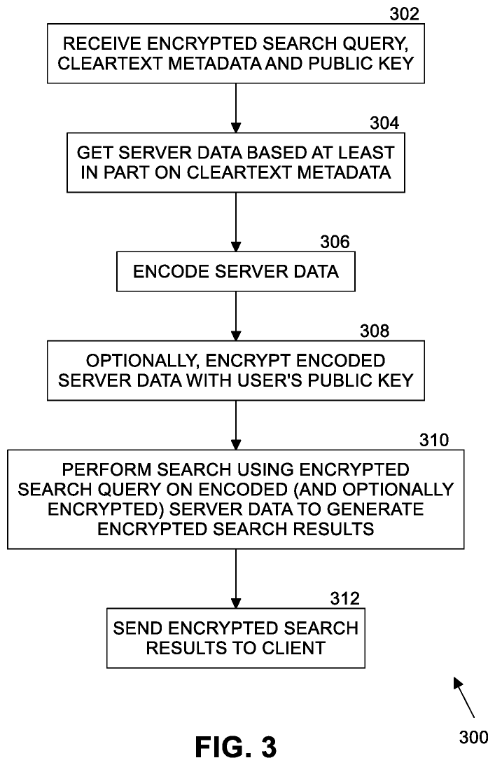

FIG. 3 is a flow diagram of server application processing 300 according to an example. At block 302, server search application 122 receives encrypted search query 114, cleartext metadata 116 and public key 112 from the client computing device 102. At block 304, server search application 122 gets server data based at least in part on cleartext metadata 116. At block 306, the server data 125 is encoded. At block 308, the encoded server data is optionally encrypted using the user's public key 112 (received from client computing device 102).

In an implementation, server data is optional and would depend on the search function being supported and/or the use case. For example, for the Map-Reduce example described below, the input data (e.g., the cleartext search query) is the only data being operated on (to search the input and count the unique keys), so encode block 306 and encrypt block 308 described below may be omitted. If a search function is to compare a user's input data to another set/database of data and perform a matching of the unique elements between the two data sets (e.g., a secure query), and the server computing device 120 performing the computations of server search application 122 owns the server data, then the server search application 122 would encode the server data in the same format that the original input data is encoded (those data format details would be included in the cleartext metadata 116 described above) and operate on the two data sets. In this case, there are now three entities (client application input data owner, a server entity with large database being matched (not shown in FIG. 1), and an entity with compute power (e.g., server computing device 120). In this example, the server entity who owns the large database may not have sufficient compute power and would offload search computations to server computing device 120. Then the full pipeline including both encode block 306 and encrypt block 308 would need to occur to allow server computing device 120 to run the search operations without revealing data from either the client application or the server entity with the large database.

In examples where encode block 306 and encrypt block 308 are needed the server data that is needed for the subsequent search would depend on the server search application handling the search. For example, if the search is being performed on a particular website (e.g., Wikipedia), then the server data may be, for example, a database of Wikipedia articles/keywords.

Encoding operations of block 306 depend on the algorithm being performed by server search application 122, however for the examples described above, the encoding would be the same for block 210 and block 306. The encoding type (which is essentially the input data format) is communicated as part of the cleartext metadata 116. In the examples where encode block 306 and encrypt block 308 are needed (such as a secure search query example), both the input data and the large dataset that the input data may be compared to are encoded in the same form (e.g., both may be converted to a decimal representation and stored in plaintext polynomials, and subsequently ciphertexts).

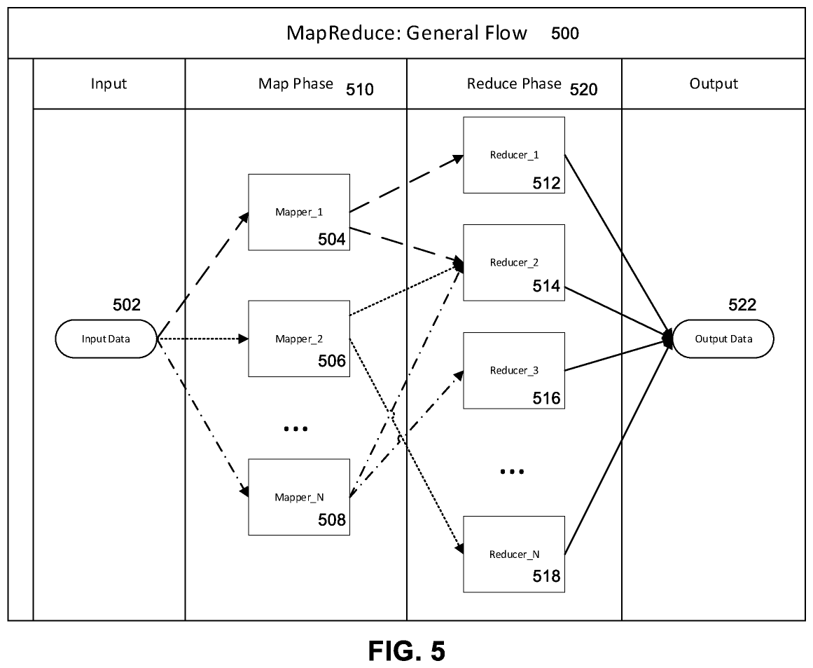

At block 310, search process using homomorphically encrypted search queries 124 performs a search process using encrypted search query 114 on the encoded (and optionally encrypted) server data to generate encrypted search results 126. Further details of an example of processing of block 310 are described in FIGS. 5 through 7 below. At block 312, server search application 122 sends encrypted search results 126 to client application 104

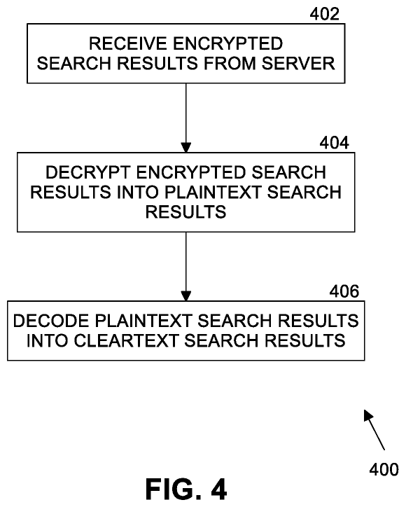

FIG. 4 is a flow diagram of client application processing 400 according to an example. At block 402, client application 104 receives encrypted search results 126 from server search application 122. At block 404, homomorphic decrypter 128 of client application 104 decrypts the encrypted search results into plaintext search results. At block 406, client application 104 decodes the plaintext search results into cleartext search results 130. The cleartext search results 130 are then available to the user (in the clear).

Search process using homomorphically encrypted search queries 124 may implement any appropriate search process. Depending on the HE process being used to implement the secure search, the details of blocks 260 to 212 of FIG. 2 and blocks 306 to 310 of FIG. 3 may be changed.

In an example, search process using homomorphically encrypted search queries 124 and block 310 of FIG. 3 implement a MapReduce process. In other examples, other search processes may be implemented. MapReduce is a programming model to assist in processing large sets of data. The MapReduce search process splits the search problem into two major stages: 1) Map—where inputs are filtered and sorted; and 2) Reduce—where the outputs from the Map phase are summed and/or grouped. This split is carried out to allow the problem to be easily distributed across a multitude of compute nodes of a server computing device(s). While there are other potential steps (splitting, shuffling, etc.), the general case is to have the Mapper and Reducer handle most of the search process work.

FIG. 5 is an example of a MapReduce flow diagram 500. Input data 502 is processed by a plurality of mappers 504, 506, . . . 508 in a Map phase 510. A plurality of reducers 512, 514, 516, . . . 518 in a Reduce phase 520 processes the outputs of the mappers to generate output data 522. In an implementation, the plurality of mappers and the plurality of reducers comprise program code executed by server computing device 120.

As is with other programming models, MapReduce is more of a guideline to follow when designing a program, than the algorithm for the program itself. As such, MapReduce can be applied to many different use cases. One of the major uses for MapReduce is in search algorithms. The massive amounts of data in a search data set that needs to be processed to handle user searches was a significant problem before the introduction of MapReduce as there wasn't a way to easily process the search data set in parallel.

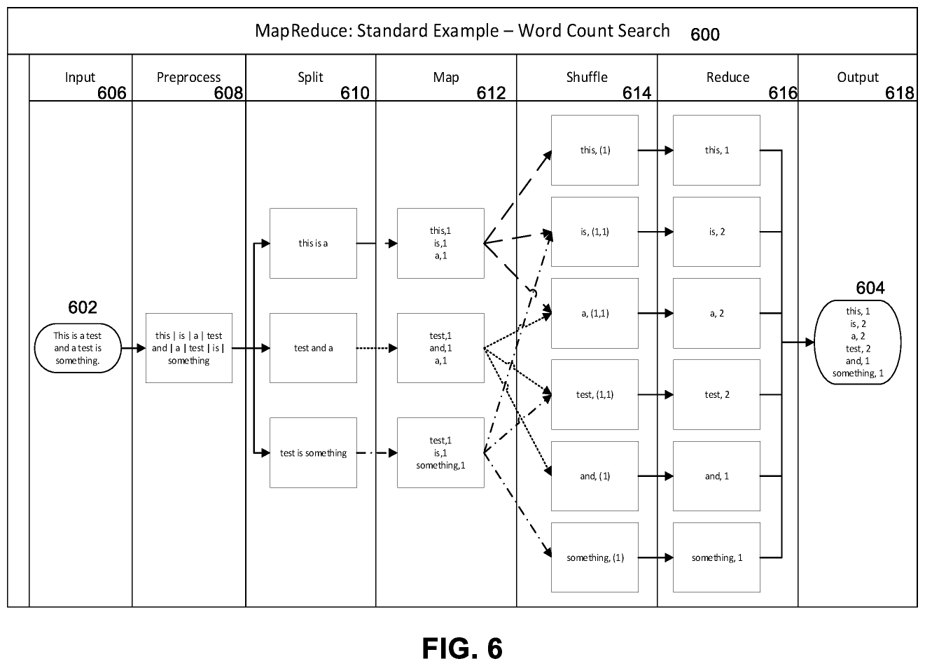

One example for the use of MapReduce is using MapReduce search for getting the word count of each element in an input block of text. FIG. 6 is a diagram 600 a word count search using MapReduce according to an example. In this example, the input data 602 is a sentence. A goal is to run a search on the input data, obtain the count of the number of unique elements in the input data, and return this information as output data 604. Although this simple example uses a short sentence as input data, the input data may much larger, such as a page of a book or even the full book itself. The size of the input data is only limited by the compute capabilities of server computing device 120.

The MapReduce process may include a plurality of processing phases. At Input phase 606, a search query (e.g., cleartext search query 106) is submitted by the user. The search query may include many components (e.g., words, letters, etc.) and the MapReduce search capability may be scaled up based on the search query and the compute capabilities of server computing device 120. At Preprocess phase 608, after receiving the input, search process using homomorphically encrypted search queries 124 preprocesses the encrypted search query 114 depending on the search problem being solved. For example, in this case, the search process removes punctuation, converts the text to lowercase (to simplify subsequent processing), and separates each word by the spaces (delimited by in the example shown in FIG. 6). At Split phase 610, the search process splits the input data 602 according to the size of the problem, the type of problem, the number of available compute nodes in server computing device 120, etc. In many cases, this means that each compute node in server computing device 120 will obtain a roughly equal portion of the search process work.

At Map phase 612, on each compute node of server computing device 120, in an example, each word may be mapped to a count, starting at ‘1’. This is true regardless of whether there are multiples of the same key on the same node. At Shuffle phase 614, the result from each of the mapper nodes may then be shuffled to group each key's counts. As with Reduce phase 616, there will be one mapper per unique key (hardware availability in server computing device 120 permitting). At Reduce phase 616, each reducer node counts the values in the list of values for that key and reduces the values down to a total for that key. At Output phase 618, output data 604 (e.g., encrypted search results 126) to be sent to the client computing device 102 is the combined results from each of the reducer nodes. The client computing device 102 receives a completed list of every unique key from the input data 602 (e.g., encrypted search query 114) and the count of the keys.

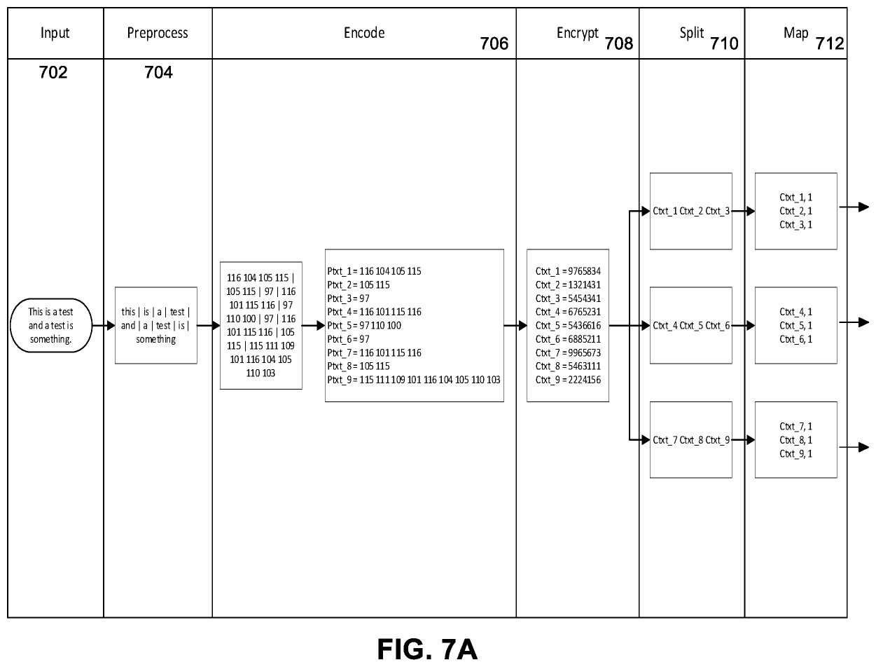

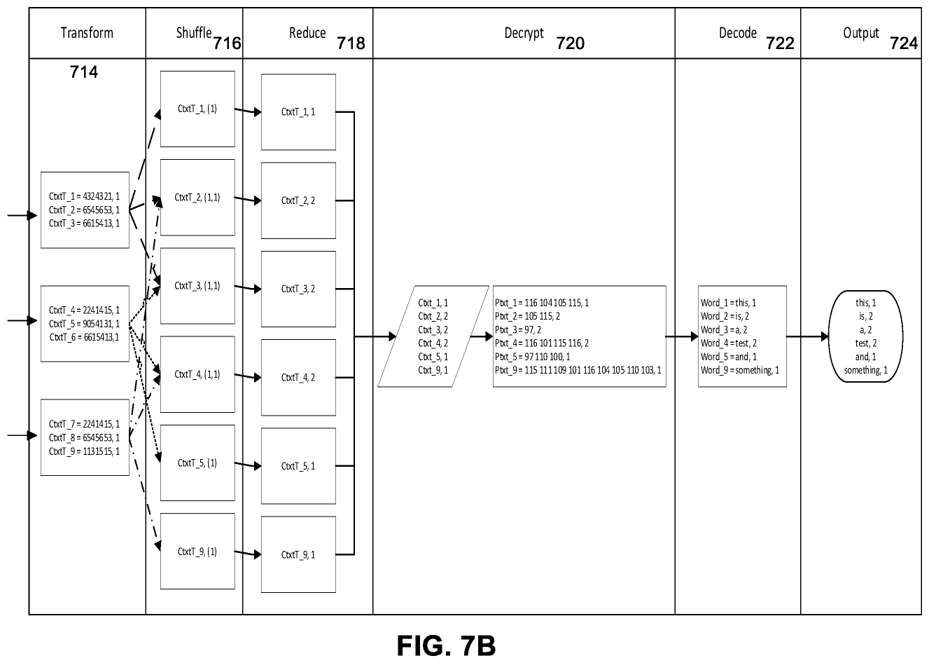

Contrary to what will be shown in the HE-example of FIG. 7 below, most of this pipeline shown in FIG. 6 takes place on the server computing device 120. As there is no privacy guaranteed to the user in the prior art example of FIG. 6, the server computing device 120 can handle each of the steps of the pipeline. If the user wanted to protect the privacy of the user's input data, then porting the input data (e.g., the user's search query) to the HE space involves additional steps. There are many methods of handling search (and specifically MapReduce) in HE, the same as there are many methods and/or algorithms to compute an operation (such as matrix multiplication) in cleartext. One example method (as described in “The Data Protection of MapReduce using Homomorphic Encryption” by Xu Chen and Qiming Huang, 2013 Institute of Electrical and Electronics Engineers (IEEE) Conference on Software Engineering and Social Services (ICSESS), May 23-25, 2013), is shown in FIG. 7.

FIGS. 7A and 7B are diagrams of word count search using MapReduce with homomorphic encryption according to an example. As can be seen from FIG. 7, while some phases are the same as in FIG. 6, multiple HE-related steps have been added and the division of processing responsibilities by client computing device 102 and server computing device 120 has changed. At Input phase 702, a search query (e.g., cleartext search query 106) is submitted by the user. The search query may include many components (e.g., words, letters, etc.) and the MapReduce search capability may be scaled up based on the search query and the compute capabilities of server computing device 120. At Preprocess phase 704, processing is performed similar to the previous example of FIG. 6, except that this preprocessing is performed on the client computing device 102 to maintain privacy. Also note that the HE parameters (e.g., public and private keys) are generated at this phase. The HE parameters need to be set based on the size of the input data (e.g., cleartext search query 106) and the specific HE process to be used. For the purposes of this example, the HE parameters (particularly a plaintext modulus) should be large enough to be able to represent all potential letters in the cleartext search query.

At new Encode phase 706, since HE works with numbers and not letters, the client application 104 needs to convert the input data (e.g., cleartext search query) into a numeric representation of the words. In an example, the American Standard Code for Information Interchange (ASCII) decimal representation may be used as the highest number needed to represent all the characters would be ‘127’. First, each letter of each word is converted to the ASCII representation of that letter. Next, those numbers are encoded into plaintext (Ptxt), one word per plaintext and one letter per slot (e.g., at encoded at block 210 of FIG. 2).

FIG. 7A shows an example of a formatted cleartext search query in Preprocess phase 704 and the first half of the Encode phase 706. As the example is showing Word-Count Search, the Preprocess phase 704 parses the input (a sentence in this case), delimits on spaces, removes punctuation, and coverts the text to lowercase. Afterward, the first half of Encode phase 706 formats the separated words into their decimal (ASCII->decimal) representation. The final cleartext formatted representation is shown in Encode phase 706 where there are nine different “arrays” of numbers (in this example), where each index in each array represents a word, and each index of each array represents a letter in that word. After that point, the cleartext is converted to plaintext during the second part of Encode phase 706.

At new Encrypt phase 708, the selected HE method includes the following steps (e.g., performed by homomorphic encrypter 108): 1) Pick two large (e.g., 512, 1,024, 2048, etc.) primes X (this is the secret key) and Y; 2) Set Z=X*Y; 3) Pick a random positive integer K; and 4) Implement a modified HE process whereby Encryption: Cleartext (Ctxt)=(Message+X*K) mod Z; and Decryption: Message=Ctxt mod X (where Message is the cleartext search query 106 and/or cleartext search results 130, for example). The plaintext is encrypted using the encryption formula. In the simple example of FIG. 7, this would be performed for all nine words in the input data, resulting in nine separate ciphertexts. At this point, the contents of the ciphertexts are fully hidden and the ciphertexts (e.g., comprising the encrypted search query 114) can now be sent over the client-server boundary (e.g., network 118) without fear of leaking private information.

The Y large prime number is also sent to the server computer device 120 for later use. The Y large prime number should be sent over a secure channel between the client computing device 102 and the server computing device 120. The Y in this case is used during encryption to functionally allow the comparison operation to occur during the Transform phase 714 (e.g., Transformed Comparable Ciphertext (CtxtT) as CtxtT=Ctxt*Y*Rand( ) where Rand( ) returns a random positive integer). In this case, Y may used for an additional “encrypt” which is the Transform stage, used to allow comparisons between transformed Ciphertexts, though not the public key. In this example there's only one set of inputs coming from the data owner (client application 104) and no additional input coming from any other entity that would need to be encrypted using a public key, though if there were, they'd use the same encryption with knowledge of Z and the product of X*K (but not X itself).

At Split phase 710, the server computing device 120 splits processing of the input data among available compute nodes. As with the non-HE example, it can be assumed that the input data at Split phase 710 is split evenly among the available compute nodes. For example, the ciphertexts may be split evenly at three ciphertexts per compute node. At Map phase 712, each compute node makes sure that each word is mapped to a count, starting with a value of ‘1’ mapped to the key that is each ciphertext. At new Transform phase 714, server search application 122 implements search process using homomorphically encrypted search queries 124 (for example, the Chen and Huan method), but includes an added step between the Map phase 712 and Shuffle phase 716 to convert the ciphertexts into a comparable state. The Reduce phase 718 needs to be able to compare whole ciphertexts to each other to find equivalent ones. Since the search query is encrypted at Encrypt phase 708, the ciphertexts can be converted as follows: 1) Given Ctxt=(Message+X*K) mod Z; 2) generate the Transformed Comparable Ciphertext (CtxtT) as CtxtT=Ctxt*Y*Rand( ) where Rand( ) returns a random positive integer; 3) As shown by the Chen and Huang method, if CtxtT_1==CtxtT_2 then Message_1==Message 2; and 4) Each compute node runs their assortment of ciphertexts through the Transform function of step 2) to generate a new Transformed Ciphertext, and makes the Transform result the new Key of the Key, Value pair.

At Shuffle phase 716, as before with the non-HE example, the keys of the Key, Value pairs may be sorted into compute nodes with one Key per node where the “Value” is the list of values for that key. This can be done as after the Transform phase 714, while the exact ciphertext contents are still hidden, and search process using homomorphically encrypted search queries 124 can now tell which ciphertexts are equivalent to other ciphertexts in the batch. As such, unique ciphertexts may be grouped. In this case, there are six unique ciphertexts, six separate compute nodes may be used. At Reduce phase 718, as before with the non-HE example, each Reducer node counts the values in the list of values for that key and reduce the list down to a total for that key. These Key, Value pairs of ciphertexts and word counts may be returned to the client application 104 as a payload (e.g., encrypted search results 126).

At new Decrypt phase 720, this step is added as the inverse of Encrypt phase 708. The client application 104 (e.g., using homomorphic decrypter 128) decrypts the encrypted ciphertexts to get back their plaintext representation. While this may not be necessary if the server kept the ciphertexts similarly labeled, decrypting will guarantee which exact words have what counts as opposed to trusting that the server kept the same order/labeling of Ciphertexts that was originally provided with the input. As mentioned in Encrypt phase 708 above, decryption would be carried out as Message=Ctxt mod X. At new Decode phase 722, this step is added as the inverse of Encode phase 706. As such, the encoded number representation of the letters is first extracted from the six plaintexts. Then the ASCII decimal representation of the numbers are converted back to their character form. Finally, at Output phase 724, the letters extracted from each plaintext are combined back into their full “word form” and the user now has which words were repeated along with their counts. Throughout this process, the cleartext search query and the cleartext search results are not available to the server search application 122.

While an example manner of implementing the technology described herein is illustrated in FIGS. 1-7, one or more of the elements, processes, and/or devices illustrated in FIGS. 1-7 may be combined, divided, re-arranged, omitted, eliminated, and/or implemented in any other way. Further, the example improved computing system 100 may be implemented by hardware, software, firmware, and/or any combination of hardware, software, and/or firmware. Thus, for example, any portion or all of the improved computing system could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example hardware resources is/are hereby expressly defined to include a non-transitory computer readable storage device or storage disk such as a memory, a digital versatile disk (DVD), a compact disk (CD), a Blu-ray disk, etc., including the software and/or firmware. Further still, the example embodiments of FIGS. 1-7 may include one or more elements, processes, and/or devices in addition to, or instead of, those illustrated in FIGS. 1-7, and/or may include more than one of any or all the illustrated elements, processes and devices.

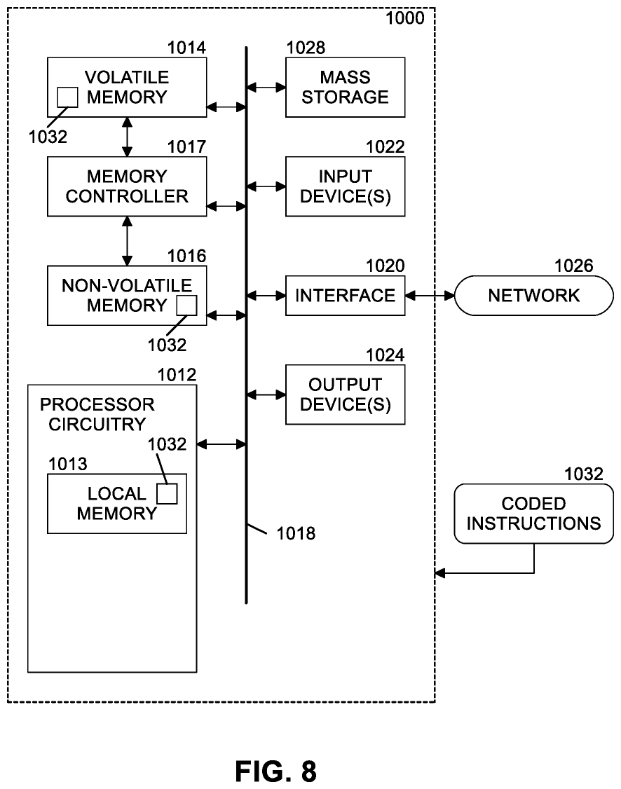

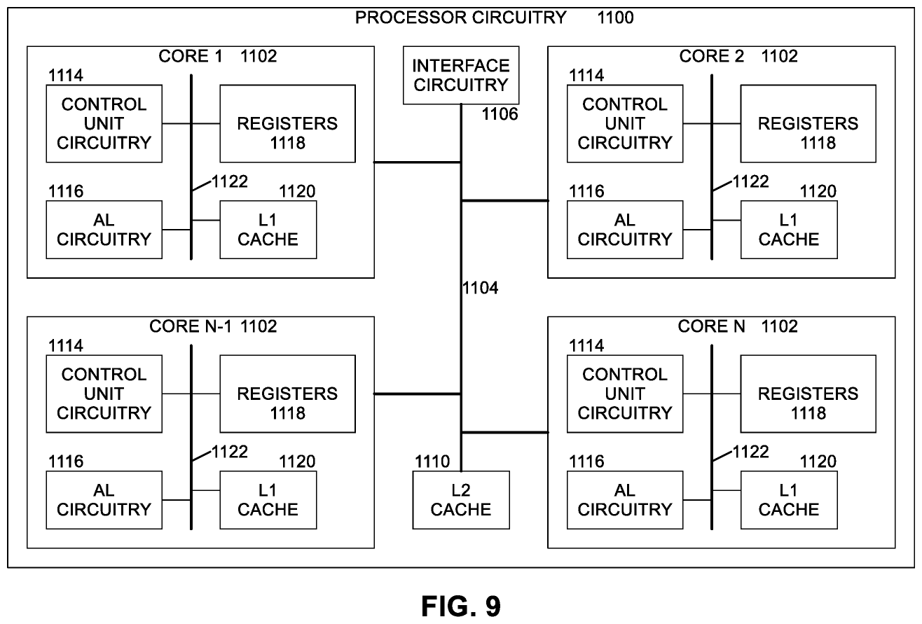

Flowcharts representative of example hardware logic circuitry, machine readable instructions, hardware implemented state machines, and/or any combination thereof is shown in FIGS. 2-4. The machine readable instructions may be one or more executable programs or portion(s) of an executable program for execution by processor circuitry, such as the processor circuitry 1012 shown in the example processor platform 1000 discussed below in connection with FIG. 8 and/or the example processor circuitry discussed below in connection with FIGS. 9 and/or 10. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The tangible machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 2-4, many other methods of implementing the example computing system may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 2-4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a block diagram of an example processor platform 1000 structured to execute and/or instantiate the machine-readable instructions and/or operations of FIGS. 1-7. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1032, which may be implemented by the machine-readable instructions and/or operations of FIGS. 1-7, may be stored in the mass storage device 1028, in the volatile memory 1014, in the non-volatile memory 1016, and/or on a removable non-transitory computer readable storage medium such as a CD or DVD.

FIG. 9 is a block diagram of an example implementation of the processor circuitry 1012 of FIG. 8. In this example, the processor circuitry 1012 of FIG. 9 is implemented by a microprocessor 1100. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all the machine-readable instructions and/or operations represented by the flowchart of FIGS. 2-4.

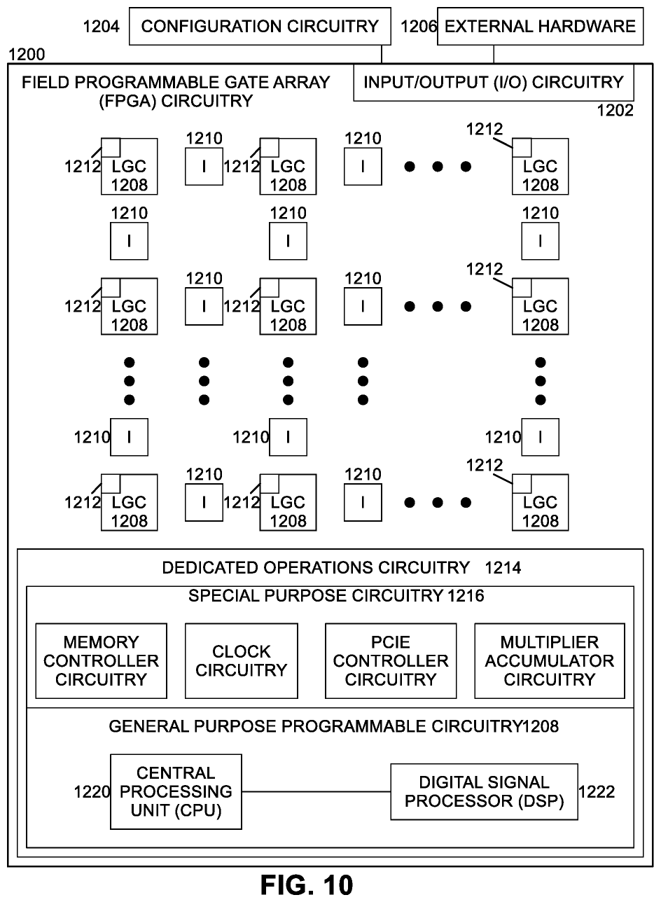

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_ cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache in local memory 1120, and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 9. Alternatively, the registers 1118 may be organized in any other arrangement, format, or structure including distributed throughout the core 1102 to shorten access time. The bus 1104 may implement at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 10 is a block diagram of another example implementation of the processor circuitry 1012 of FIG. 8. In this example, the processor circuitry 1012 is implemented by FPGA circuitry 1200. The FPGA circuitry 1200 can be used, for example, to perform operations that could otherwise be performed by the example microprocessor 1100 of FIG. 9 executing corresponding machine-readable instructions. However, once configured, the FPGA circuitry 1200 instantiates the machine-readable instructions in hardware and, thus, can often execute the operations faster than they could be performed by a general-purpose microprocessor executing the corresponding software.

More specifically, in contrast to the microprocessor 1100 of FIG. 9 described above (which is a general purpose device that may be programmed to execute some or all of the machine readable instructions represented by the flowcharts of FIGS. 2-4 but whose interconnections and logic circuitry are fixed once fabricated), the FPGA circuitry 1200 of the example of FIG. 10 includes interconnections and logic circuitry that may be configured and/or interconnected in different ways after fabrication to instantiate, for example, some or all of the machine readable instructions represented by the flowcharts of FIGS. 2-4. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowchart of FIG. 2. As such, the FPGA circuitry 1200 may be structured to effectively instantiate some or all the machine-readable instructions of the flowcharts of FIGS. 2-4 as dedicated logic circuits to perform the operations corresponding to those software instructions in a dedicated manner analogous to an ASIC. Therefore, the FPGA circuitry 1200 may perform the operations corresponding to the some or all the machine-readable instructions of FIGS. 2-4 faster than the general-purpose microprocessor can execute the same.

In the example of FIG. 10, the FPGA circuitry 1200 is structured to be programmed (and/or reprogrammed one or more times) by an end user by a hardware description language (HDL) such as Verilog. The FPGA circuitry 1200 of FIG. 10, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 9. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine-readable instructions of FIGS. 2-4 and/or other desired operations. The logic gate circuitry 1208 shown in FIG. 10 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 10 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 9 and 10 illustrate two example implementations of the processor circuitry 1012 of FIG. 8, many other approaches are contemplated. For example, as mentioned above, modern FPGA circuitry may include an on-board CPU, such as one or more of the example CPU 1220 of FIG. 10. Therefore, the processor circuitry 1012 of FIG. 8 may additionally be implemented by combining the example microprocessor 1100 of FIG. 9 and the example FPGA circuitry 1200 of FIG. 10. In some such hybrid examples, a first portion of the machine-readable instructions represented by the flowcharts of FIGS. 2-4 may be executed by one or more of the cores 1102 of FIG. 9 and a second portion of the machine-readable instructions represented by the flowcharts of FIGS. 2-4 may be executed by the FPGA circuitry 1200 of FIG. 10.

In some examples, the processor circuitry 1012 of FIG. 8 may be in one or more packages. For example, the microprocessor 1100 of FIG. 9 and/or the FPGA circuitry 1200 of FIG. 10 may be in one or more packages. In some examples, an XPU may be implemented by the processor circuitry 1012 of FIG. 8, which may be in one or more packages. For example, the XPU may include a CPU in one package, a DSP in another package, a GPU in yet another package, and an FPGA in still yet another package.

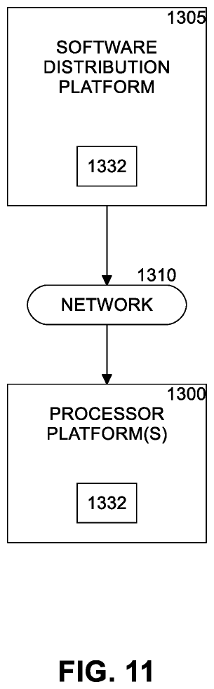

A block diagram illustrating an example software distribution platform 1305 to distribute software such as the example machine readable instructions 1032 of FIG. 8 to hardware devices owned and/or operated by third parties is illustrated in FIG. 11. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 8. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine readable instructions, as described above. The one or more servers of the example software distribution platform 1305 are in communication with a network 1310, which may correspond to any one or more of the Internet and/or any of the example networks, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine readable instructions described above, may be downloaded to the example processor platform 1300, which is to execute the machine-readable instructions 1032 to implement the methods described above and associated computing system 100. In some examples, one or more servers of the software distribution platform 1305 periodically offer, transmit, and/or force updates to the software (e.g., the example machine readable instructions 1032 of FIG. 8) to ensure improvements, patches, updates, etc., are distributed and applied to the software at the end user devices.

In some examples, an apparatus includes means for data processing of FIGS. 1-7. For example, the means for processing may be implemented by processor circuitry, processor circuitry, firmware circuitry, etc. In some examples, the processor circuitry may be implemented by machine executable instructions executed by processor circuitry, which may be implemented by the example processor circuitry 1012 of FIG. 8, the example microprocessor 1100 of FIG. 9, and/or the example Field Programmable Gate Array (FPGA) circuitry 1200 of FIG. 10. In other examples, the processor circuitry is implemented by other hardware logic circuitry, hardware implemented state machines, and/or any other combination of hardware, software, and/or firmware. For example, the processor circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

From the foregoing, it will be appreciated that example systems, methods, apparatus, and articles of manufacture have been disclosed that provide improved security in a computing system. The disclosed systems, methods, apparatus, and articles of manufacture improve the performance of implementing a privacy-protected search in a computing system. The disclosed systems, methods, apparatus, and articles of manufacture are accordingly directed to one or more improvement(s) in the operation of a machine such as a computer or other electronic and/or mechanical device.

The following examples pertain to further embodiments. Specifics in the examples may be used anywhere in one or more embodiments. Example 1 is a method including receiving, by a server computing device, an encrypted search query and cleartext metadata associated with the encrypted search query from a client computing device; performing a search using the encrypted search query to generate encrypted search results; and sending the encrypted search results to the client computing device. In Example 2, the subject matter of Example 1 optionally includes getting server data based at least in part on the cleartext metadata; encoding the server data; and performing the search on the encoded server data using the encrypted search query to generate the encrypted search results. In Example 3, the subject matter of Example 2 optionally includes encrypting the encoded server data with a homomorphic encryption public key prior to performing the search using the encrypted search query. In Example 4, the subject matter of Example 1 optionally includes wherein the encrypted search query is encrypted with a homomorphic encryption process. In Example 5, the subject matter of Example 4 optionally includes wherein a cleartext search query is encoded into at least one plaintext polynomial and the at least one plaintext polynomial is encrypted with a homomorphic encryption private key of the homomorphic encryption process, and comprising receiving, by the server computing device, a homomorphic encryption public key of the homomorphic encryption process. In Example 6, the subject matter of Example 5 optionally includes wherein the cleartext metadata is extracted from the cleartext search query.

Example 7 is at least one machine-readable storage medium comprising instructions which, when executed by a processor, cause the processor to receive, by a server computing device, an encrypted search query and cleartext metadata associated with the encrypted search query from a client computing device; perform a search using the encrypted search query to generate encrypted search results; and send the encrypted search results to the client computing device. In Example 8, the subject matter of Example 7 optionally includes instructions which, when executed by a processor, cause the processor to get server data based at least in part on the cleartext metadata; encode the server data; and perform the search on the encoded server data using the encrypted search query to generate the encrypted search results. In Example 9, the subject matter of Example 8 optionally includes instructions which, when executed by a processor, cause the processor to encrypt the encoded server data with a homomorphic encryption public key prior to performing the search using the encrypted search query. In Example 10, the subject matter of Example 7 optionally includes wherein the encrypted search query is encrypted with a homomorphic encryption process. In Example 11, the subject matter of Example 10 optionally includes wherein a cleartext search query is encoded into at least one plaintext polynomial and the at least one plaintext polynomial is encrypted with a homomorphic encryption private key of the homomorphic encryption process, and comprising instructions to receive, by the server computing device, a homomorphic encryption public key of the homomorphic encryption process. In Example 12, the subject matter of Example 11 optionally includes wherein the cleartext metadata is extracted from the cleartext search query.

Example 13 is a method including generating a homomorphic encryption private key and a homomorphic encryption public key; receiving a cleartext search query; extracting cleartext metadata from the cleartext search query; encoding the cleartext search query into at least one plaintext polynomial; encrypting the at least one plaintext polynomial with the homomorphic encryption public key using a homomorphic encryption process to generate an encrypted search query; and sending the encrypted search query and the cleartext metadata to a server computing device. In Example 14, the subject matter of Example 13 optionally includes receiving encrypted search results from the server computing device in response to sending the encrypted search query and the cleartext metadata; decrypting the encrypted search results with the homomorphic encryption private key using a homomorphic decryption process to generate plaintext search results; and decoding the plaintext search results into cleartext search results. In Example 15, the subject matter of Example 14 optionally includes sending the homomorphic encryption public key to the server computing device.

Example 16 is at least one machine-readable storage medium comprising instructions which, when executed by at least one processor, cause the at least one processor to generate a homomorphic encryption private key and a homomorphic encryption public key; receive a cleartext search query; extract cleartext metadata from the cleartext search query; encode the cleartext search query into at least one plaintext polynomial; encrypt the at least one plaintext polynomial with the homomorphic encryption public key using a homomorphic encryption process to generate an encrypted search query; and send the encrypted search query and the cleartext metadata to a server computing device. In Example 17, the subject matter of Example 16 optionally includes instructions which, when executed by at least one processor, cause the at least one processor to receive encrypted search results from the server computing device in response to the sending the encrypted search query and the cleartext metadata; decrypt the encrypted search results with the homomorphic encryption private key using a homomorphic decryption process to generate plaintext search results; and decode the plaintext search results into cleartext search results. In Example 18, the subject matter of Example 17 optionally include instructions which, when executed by at least one processor, cause the at least one processor to send the homomorphic encryption public key to the server computing device.

Example 19 is a system including a client computing device to generate a homomorphic encryption private key and a homomorphic encryption public key; receive a cleartext search query; extract cleartext metadata from the cleartext search query; encode the cleartext search query into at least one plaintext polynomial; encrypt the at least one plaintext polynomial with the homomorphic encryption public key using a homomorphic encryption process to generate an encrypted search query; and send the encrypted search query and the cleartext metadata; and a server computing device to receive the encrypted search query and the cleartext metadata associated with the encrypted search query from the client computing device; get server data based at least in part on cleartext metadata; encode the server data; perform a search of the encoded server data using the encrypted search query to generate encrypted search results; and send the encrypted search results to the client computing device. In Example 20, the subject matter of Example 19 optionally includes the client computing device to send the homomorphic encryption public key to the server computing device. In Example 21, the subject matter of Example 20 optionally includes the server computing device to encrypt the encoded server data with the homomorphic encryption public key prior to performing the search using the encrypted search query. In Example 22, the subject matter of Example 19 optionally includes the client computing device to receive the encrypted search results from the server computing device in response to sending the encrypted search query and the cleartext metadata; decrypt the encrypted search results with the homomorphic encryption private key using a homomorphic decryption process to generate plaintext search results; and decode the plaintext search results into cleartext search results.

Example 23 is an apparatus operative to perform the method of any one of Examples 1 to 6 or 13 to 15. Example 24 is an apparatus that includes means for performing the method of any one of Examples 1 to 6 or 13 to 15. Example 25 is an apparatus that includes any combination of modules and/or units and/or logic and/or circuitry and/or means operative to perform the method of any one of Examples 1 to 6 or 13 to 15. Example 26 is an optionally non-transitory and/or tangible machine-readable medium, which optionally stores or otherwise provides instructions that if and/or when executed by a computer system or other machine are operative to cause the machine to perform the method of any one of Examples 1 to 6 or 13 to 15.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the examples of this patent.

What is claimed is:

1. A method comprising:
receiving, by a server computing device, an encrypted search query and cleartext metadata associated with the encrypted search query from a client computing device;
performing a search using the encrypted search query to generate encrypted search results; and
sending the encrypted search results to the client computing device.

2. The method of claim 1, comprising:
getting server data based at least in part on the cleartext metadata;
encoding the server data; and
performing the search on the encoded server data using the encrypted search query to generate the encrypted search results.

3. The method of claim 2, comprising encrypting the encoded server data with a homomorphic encryption public key prior to performing the search using the encrypted search query.

4. The method of claim 1, wherein the encrypted search query is encrypted with a homomorphic encryption process.

5. The method of claim 4, wherein a cleartext search query is encoded into at least one plaintext polynomial and the at least one plaintext polynomial is encrypted with a homomorphic encryption private key of the homomorphic encryption process, and comprising receiving, by the server computing device, a homomorphic encryption public key of the homomorphic encryption process.

6. The method of claim 5, wherein the cleartext metadata is extracted from the cleartext search query.

7. At least one machine-readable storage medium comprising instructions which, when executed by a processor, cause the processor to:
receive, by a server computing device, an encrypted search query and cleartext metadata associated with the encrypted search query from a client computing device;
perform a search using the encrypted search query to generate encrypted search results; and
send the encrypted search results to the client computing device.

8. The at least one machine-readable storage medium of claim 7, comprising instructions which, when executed by a processor, cause the processor to:
get server data based at least in part on the cleartext metadata;
encode the server data; and
perform the search on the encoded server data using the encrypted search query to generate the encrypted search results.

9. The at least one machine-readable storage medium of claim 8, comprising instructions which, when executed by a processor, cause the processor to encrypt the encoded server data with a homomorphic encryption public key prior to performing the search using the encrypted search query.

10. The at least one machine-readable storage medium of claim 7, wherein the encrypted search query is encrypted with a homomorphic encryption process.

11. The at least one machine-readable storage medium of claim 10, wherein a cleartext search query is encoded into at least one plaintext polynomial and the at least one plaintext polynomial is encrypted with a homomorphic encryption private key of the homomorphic encryption process, and comprising instructions to receive, by the server computing device, a homomorphic encryption public key of the homomorphic encryption process.

12. The at least one machine-readable storage medium of claim 11, wherein the cleartext metadata is extracted from the cleartext search query.

13. A system comprising:
a client computing device to
generate a homomorphic encryption private key and a homomorphic encryption public key;
receive a cleartext search query;
extract cleartext metadata from the cleartext search query;
encode the cleartext search query into at least one plaintext polynomial;
encrypt the at least one plaintext polynomial with the homomorphic encryption public key using a homomorphic encryption process to generate an encrypted search query; and
send the encrypted search query and the cleartext metadata; and
a server computing device to
receive the encrypted search query and the cleartext metadata associated with the encrypted search query from the client computing device;
get server data based at least in part on cleartext metadata;
encode the server data;
perform a search of the encoded server data using the encrypted search query to generate encrypted search results; and
send the encrypted search results to the client computing device.

14. The system of claim 13, comprising the client computing device to send the homomorphic encryption public key to the server computing device.

15. The system of claim 14, comprising the server computing device to encrypt the encoded server data with the homomorphic encryption public key prior to performing the search using the encrypted search query.

16. The system of claim 13, comprising the client computing device to:
receive the encrypted search results from the server computing device in response to sending the encrypted search query and the cleartext metadata;
decrypt the encrypted search results with the homomorphic encryption private key using a homomorphic decryption process to generate plaintext search results; and
decode the plaintext search results into cleartext search results.
